(19) United States
(12) Patent Application Publication
(10) Pub. No.: US 2025/0142121 A1
(43) Pub. Date: May 1, 2025

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Yingzhan XU, Beijing (CN); Wenyi Wang, Beijing (CN); Kai Zhang, Los Angeles, CA (US); Li Zhang, Los Angeles, CA (US)

(21) Appl. No.: 19/009,860

(22) Filed: Jan. 3, 2025

Related U.S. Application Data
(63) Continuation of application No. PCT/CN2023/105225, filed on Jun. 30, 2023.

(30) Foreign Application Priority Data
Jul. 4, 2022 (WO) PCT/CN2022/103767
Jul. 9, 2022 (WO) PCT/CN2022/104778

(51) Int. Cl. H04N 19/597; H04N 19/132; H04N 19/137; H04N 19/147; H04N 19/184; H04N 19/537

(52) U.S. Cl. CPC H04N 19/597; H04N 19/132; H04N 19/137; H04N 19/147; H04N 19/184; H04N 19/537

(57) ABSTRACT

Embodiments of the present disclosure provide a solution for point cloud coding. A method for point cloud coding is proposed. The method comprises: obtaining, for a conversion between a current point cloud (PC) sample of a point cloud sequence and a bitstream of the point cloud sequence, target information regarding whether an attribute inter prediction is enabled for the current PC sample, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and performing the conversion based on the target information.

### CROSS REFERENCE TO RELATED APPLICATIONS

This application is a continuation of International Application No. PCT/CN2023/105225, filed on Jun. 30, 2023, which claims the benefit of International Application No. PCT/CN2022/103767, filed on Jul. 4, 2022, and International Application No. PCT/CN2022/104778, filed on Jul. 9, 2022. The entire contents of these applications are hereby incorporated by reference in their entireties.

### FIELDS

Embodiments of the present disclosure relates generally to point cloud coding techniques, and more particularly, to inter prediction for point cloud attribute coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding quality of conventional point cloud coding techniques is generally expected to be further improved.

### SUMMARY

Embodiments of the present disclosure provide a solution for point cloud coding.

In a first aspect, a method for point cloud coding is proposed. The method comprises: obtaining, for a conversion between a current point cloud (PC) sample of a point cloud sequence and a bitstream of the point cloud sequence, target information regarding whether an attribute inter prediction is enabled for the current PC sample, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and performing the conversion based on the target information.

Based on the method in accordance with the first aspect of the present disclosure, information regarding whether an attribute inter prediction is enabled for the current PC sample is determined based on related rate information and/or distortion information. Compared with the conversion solution, the proposed method can advantageously reduce the coding bits while maintaining the coding quality, and improve the coding quality of point cloud coding.

In a second aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by an apparatus for point cloud coding. The method comprises: obtaining target information regarding whether an attribute inter prediction is enabled for a current point cloud (PC) sample of the point cloud sequence, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and generating the bitstream based on the target information.

In a fifth aspect, a method for storing a bitstream of a point cloud sequence is proposed. The method comprises: obtaining target information regarding whether an attribute inter prediction is enabled for a current point cloud (PC) sample of the point cloud sequence, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; generating the bitstream based on the target information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates a flowchart of a method for point cloud coding in accordance with some embodiments of the present disclosure; and

FIG. 5 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

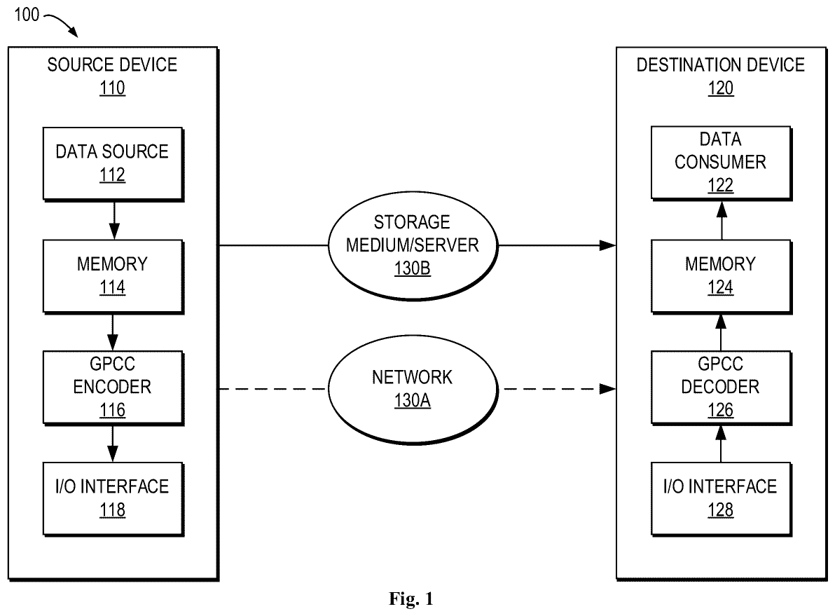

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre- captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

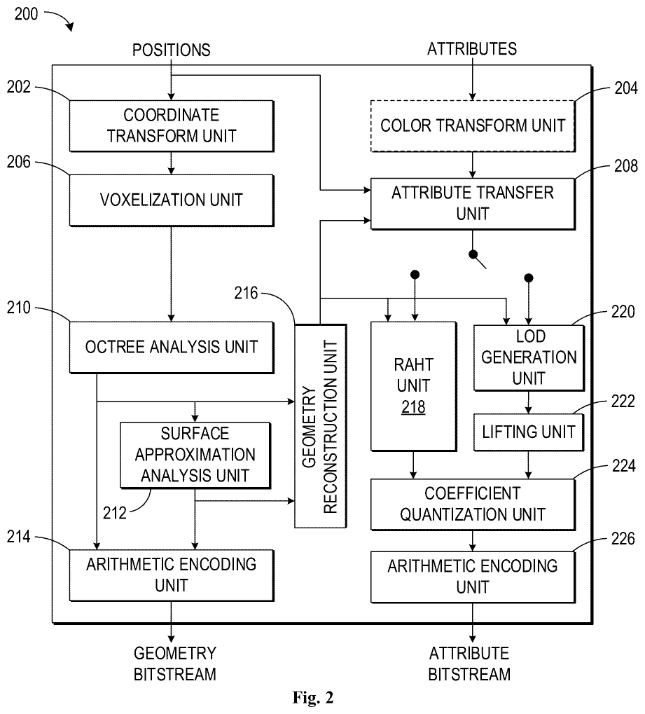

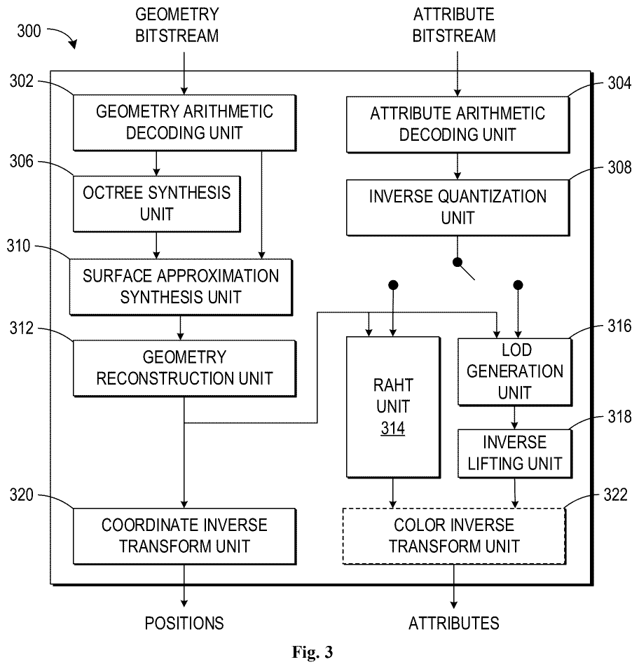

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is related to point cloud attribute prediction in inter prediction. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
LOD Level of Detail
CE Core Experiment
EE Exploration Experiment
inter-EM Inter Exploration Model
PC Point Cloud
RDO Rate-distortion Optimization

### 3. Introduction

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions.

To explore the future point cloud coding technologies in G-PCC, Core Experiment (CE) 13.5 and Exploration Experiment (EE) 13.2 were formed to develop inter prediction technologies in G-PCC. Since then, many new inter prediction methods have been adopted by MPEG and put into the reference software named inter Exploration Model (inter-EM).

In one point cloud, there may be geometry information and attribute information. Geometry information is used to describe the geometry locations of the data points. Attribute information is used to record some details of the data points, such as textures, normal vectors, reflections and so on. Point cloud codec can process the various information in different ways. Usually there are many optional tools in the codec to support the coding and decoding of geometry information and attribute information respectively.

### 3.1 Attribute Intra Prediction

In G-PCC, two attribute coding methods have been proposed by using the geometry information to perform the attribute intra prediction.

### 3.1.1 Predicting Transform

Predicting transform is an interpolation-based hierarchical nearest neighbors prediction method, which is typically used for sparse point cloud content. Firstly, a level of detail (LOD) structure is generated. Secondly, the nearest neighbors are searched based on the LOD structure. Then, the attribute prediction is performed based on the search results.

### 3.1.1.1 LOD Generation

In the LOD generation process, the geometry information is leveraged to build a hierarchical structure of the point cloud, which defines a set of “level of details”. The hierarchical structure is exploited to predict attributes efficiently. It also makes it possible to provide advanced functionalities such as progressive transmission and scalable rendering.

The LOD generation process re-organizes the point cloud points into a set of refine level (points set) R₀, R₁, . . . , R_{L-1} according to the user-defined parameter L which indicates LOD number. Then the attribute of point cloud points are encoded from R₀ to R_{L-1}. The level of detail l, LODₗ, can be obtained by taking the union of the refinement levels R₀, R₁, . . . , Rₗ:

$${LOD}_{l} = {R}_{0} ⋃ {R}_{1} ⋃ ⋯ ⋃ {R}_{l} \qquad ( 3 - 1 )$$

3.1.1.2 Nearest Neighbors Search considering Point Distribution

In G-PCC, two neighbor lists, list1 and list2, are built to search 3 approximately nearest neighbors of the current point. List1 contains 3 approximately nearest neighbors which are obtained by a LOD based approximately nearest neighbors search algorithm. List2 contains 3 points that are dropped out when updating list1.

Considering the point distribution information, the concept of strict opposite and loose opposite are defined. According to the relative position with the current point (x, y, z), every nearest neighbor point (xₙ, yₙ, zₙ) is assigned to a direction index dirIdx. According to the direction index dirIdx, strict opposite and loose opposite are defined as table 3-1.

TABLE 3-1
the definition strict opposite and loose
opposite according direction index dirIdx

| strict opposite | loose opposite |
|---|---|
| 0 ↔ 7 | 0 ↔ 3, 5, 6 |
| 1 ↔ 6 | 1 ↔ 2, 4, 7 |
| 2 ↔ 5 | 2 ↔ 1, 4, 7 |
| 3 ↔ 4 | 3 ↔ 0, 5, 6 |
| — | 4 ↔ 1, 2, 7 |
| — | 5 ↔ 0, 3, 6 |
| — | 6 ↔ 0, 3, 5 |
| — | 7 ↔ 1, 2, 4 |

The final neighbor list is generated by updating list1 using points in list2 with a strict opposite eligibility check and a loose opposite eligibility check. Note that the point number of final list1 may be less than 3 because there are not enough neighbors, and a neighbor pruning process is performed.

### 3.1.1.3 Attribute Prediction

After obtaining list1, multiple predictor candidates are created based on list1. Each predictor candidate is assigned with one index. Then, the variability of the attributes of the points in list1 is computed. If the variability is less than a threshold, the weighted average value is used to predict the attribute of the current point. Otherwise, the best predictor is selected by applying a rate-distortion optimization (RDO) procedure.

### 3.1.2 Lifting Transform

The lifting transform is typically used for dense point cloud content and is builded on top of the predicting transform method. The main difference between lifting transform and prediction transform is the update operator and adaptive quantization strategy. In lifting transform, each point is associated with an influence weight value. Points in lower LODs are used more often and assigned with higher weight values. The influence weight is used in the quantization processes.

### 3.2 Attribute Inter Prediction

In inter-EM, some inter prediction tools have been proposed to perform attribute inter coding. There is one list1 to store the nearest neighbors in current frame and the previous one frame. The attributes of the points in the list are used to generate the predictor candidates and get the predicted value of the current point in the similar way as in intra frame coding.

Firstly, the points in the current frame and the reference frame are reordered based on the Morton code. Each point is associated with one Morton index to show the Morton order.

Then, for each point, the nearest neighbors search is performed in the current frame and the reference frame. There is one parameter, Search_Range, to control the search range.
a) In the current frame, the previous Search_Range points of the current point in Morton order are traversed.
b) In the reference frame, the search center is the point with the same Morton index in the reference frame. The previous Search_Range points before the search center, the following Search_Range points after the search center and the search center point are searched.

The nearest neighbors search is based on the Euclidean distance from the searched point to the current point. 3 nearest points are selected and stored in the list1. It should be noted that the weights of the points from the reference frame should be lower than those points from the current frame.

Finally, multiple predictor candidates are created based on the list1 and the predicted attribute value is generated in the similar way with the intra coding.

### 4. Problems

The existing designs for point cloud attribute inter prediction have the following problems:
1. In current inter-EM, the search center in the reference frame is the point with the same Morton index. However, there is no strict correspondence between the reordered points in the current frame and the reference frame. In some cases, the points with the same Morton index have very different geometric positions which leads to inaccurate search and prediction results.
2. In current inter-EM, the nearest search is performed based on the Euclidean distance. The calculation of Euclidean distance has high complexity which affects the overall complexity of the encoding and decoding.
3. In current inter-EM, the search ranges in the current frame and reference frame are the same. However, the points in the current frame and points in difference frames have different effects on the current point. Using the same search range will limit the prediction efficiency.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner. In the following description, list1 may be the list which stores the nearest neighbors.

1) It is proposed to indicate whether the inter prediction is applied to one frame.
a. In one example, the inter prediction may be not applied to one frame.
   i. In one example, the frame may be one random access point frame.
   ii. In one example, the frame may be one I-frame.
b. In one example, the inter prediction may be applied to one frame.
c. In one example, there may be at least one indication to indicate whether the inter prediction is applied to one frame.
   i. In one example, the indication may be signalled to the decoder.
      (1) In one example, the indication may be coded with fixed-length coding, unary coding, truncated unary coding, etc. al.
      (2) In one example, the indication may be coded in a predictive way.
         2) It is proposed to indicate whether the attribute inter prediction is enabled to one frame.
a. In one example, the attribute inter prediction may be applied to one frame if the inter prediction is applied to the frame and attribute inter prediction is enabled.
b. In one example, there may be at least one indication to indicate whether the attribute inter prediction is enabled to one frame.
   i. In one example, the indication may be signalled to the decoder.
      (1) In one example, the indication may be coded with fixed-length coding, unary coding, truncated unary coding, etc. al.
      (2) In one example, the indication may be coded in a predictive way.
         3) It is proposed that at least one search center may be derived for the nearest neighbor search in attribute inter prediction.
a. In one example, the nearest neighbors search may be performed within a given frame to be searched.
   i. In one example, the given frame to be searched may be the current frame.
   ii. In one example, the given frame to be searched may be another frame.
   iii. In one example, the given frame to be searched may be a reference frame of the current frame.
b. In one example, the points in a given frame to be searched may be reordered before the nearest neighbor search.
   i. In one example, the reordering may be performed based on the Morton codes, Hilbert codes or other converted codes of the points.
   ii. In one example, the reordering may be performed based on the polar coordinates of the points.
   iii. In one example, the reordering may be performed based on the spherical coordinates of the points.
   iv. In one example, the reordering may be performed based on the cylindrical coordinates of the points.
   v. In one example, the reordering may be performed based on the scanning order of the radar.
   vi. In one example, the searching will be conducted following an order (which may be reordered) of the points.
c. In one example, there may be one search center for a given frame to be searched.
   i. In one example, the previous points before the search center in the reordered order and the search center may be searched.
   ii. In one example, the following points after the search center in the reordered order and the search center may be searched.
   iii. In one example, the previous points before the search center in the reordered order, the search center and the following points after the search center in the reordered order may be searched.
d. In one example, the search center may be an approximate nearest point in geometric location in the frame to be searched.
   i. In one example, the search center may be selected from all points or partial points in the frame to be searched.
   ii. In one example, the search center may be the point with the nearest distance from the current point.
      (1) The distance may be the Euclidean distance, the Manhattan distance, the Chebyshev distance and so on.
   iii. In one example, the search center may be the point with the approximate nearest distance from the current point.
      (1) The search center may be selected from partial points in the frame to be searched.
      (2) The distance may be the Euclidean distance, the Manhattan distance, the Chebyshev distance and so on.
   iv. In one example, the search center may be the point with the nearest distance on the converted codes from the current point.
      (1) The distance may be the difference on the converted codes.
      (2) The converted codes may be the Morton codes, Hilbert codes and so on.
   v. In one example, the search center may be the point with the approximate nearest distance on the converted codes from the current point.
      (1) The search center may be selected from partial points in the frame to be searched.
      (2) In one example, the partial points may be the points whose converted codes are greater than the current point converted code.
      (3) In one example, the partial points may be the points whose converted codes are less than the current point converted code.
      (4) The distance may be the difference on the converted codes.
      (5) The converted codes may be the Morton codes, Hilbert codes and so on.

e. In one example, multiple (such as N) search centers may be derived.
i. Alternatively, furthermore, the search may be conducted from one or multiple of the search centers.
ii. In one example, the N search centers may be the N points with the N nearest distances from the current point.
iii. In one example, the N search centers may be the N points with the N nearest distances on the converted codes from the current point.
   4) It is proposed to use different search ranges in different directions and/or different frames.
a. In one example, there may be at least one search range for one frame to be searched.
   i. In one example, there may be one search range to indicate the number of points before the search center which need to be searched.
   ii. In one example, there may be one search range to indicate the number of points after the search center which need to be searched.
   iii. In one example, there may be one search range to indicate both the number of points before the search center and the number of points after the search center which need to be searched.
b. In one example, there may be different search ranges for the current frame and the reference frame(s).
c. In one example, the search range of difference reference frames may be different.
d. In one example, the search ranges for attribute intra prediction and attribute inter prediction may be different.
e. In one example, the search ranges for attribute intra prediction and attribute inter prediction may be the same.
f. In one example, the search range for attribute intra prediction of the frame with attribute inter prediction may be different with that of the frame with only attribute intra prediction may be different.
g. In one example, the search range may be derived at the encoder.
h. In one example, the search range may be derived at the decoder.
i. In one example, the search ranges of different coded points in current frame and/or the reference frames(s) may be different.
j. In one example, the search ranges of different coded points in current frame and/or the reference frames(s) may be the same.
k. In one example, the search ranges of different LODs in the current frame and/or the reference frame(s) may be different.
l. In one example, the search ranges of different LODs in the current frame and/or the reference frame(s) may be the same.
m. In one example, the search ranges among current refine level, lower LOD and higher LOD in the current frame and/or the reference frame(s) may be different.
n. In one example, the search ranges among current refine level, lower LOD and higher LOD in the current frame and/or the reference frame(s) may be the same.
o. In one example, the search ranges of different slices/tiles in the current frame and/or the reference frame(s) may be different.
p. In one example, the search ranges of different slices/tiles in the current frame and/or the reference frame(s) may be the same.
   5) It is proposed to signal the search range to the decoder by coding an indication to indicate the search range.
a. In one example, at least one indication may be signalled to the decoder to indicate the search ranges.
   i. In one example, the indication may be a pre-defined signal when the codec performs the nearest neighbors search on all points.
   ii. In one example, the indication may be selected from some pre-defined signals when the search range is selected from some pre-defined search ranges.
   iii. In one example, the indication may be the value of the search range.
   iv. In one example, the indication may be the pre-defined mathematical conversion (such as logarithm, square root and so on) of the search range.
b. In one example, the indication may be coded with fixed-length coding, unary coding, truncated unary coding, etc. al.
c. In one example, the indication may be coded in a predictive way.
   6) Different geometric distances may be used for the nearest neighbors search and neighbor weight generation in attribute inter prediction.
a. In one example, at least one points may be stored in list1 by performing nearest neighbors search in the current frame and the reference frame.
   i. In one example, the selected points may be the points with the closest geometric distance (such as the Euclidean distance, the Manhattan distance, the Chebyshev distance and so on) from the current point.
   ii. In one example, the selected points may be from the searched points which are defined by the search center and search range.
b. In one example, the geometric distance of each point in list1 may be used for neighbor weights generation.
c. In one example, the process of nearest neighbor search and neighbor weights generation may use different geometric distances.
   i. In one example, the Manhattan distance of each searched point may be used for nearest neighbors search and the Euclidean distance of each point in list1 may be used for neighbor weight generation.
      7) In one example, the attribute inter prediction may be performed in different coordinate systems.
a. In one example, the coordinate systems may be spherical coordinate system, cylindrical coordinate system, Cartesian coordinate system, Euclidean coordinate system and so on.
b. In one example, the attribute inter prediction may be performed in another coordinate system when the geometry information is represented in specific coordinate system.
c. In one example, there may be a coordinate system conversion for the geometry information of the current frame.
d. In one example, there may be a coordinate system conversion for the reference frame(s).
e. In one example, the coordinate system conversion may be performed after the geometry coding and/or before the attribute coding.
f. In one example, the coordinate system conversion may be performed at the encoder and the decoder.
g. In one example, the converted coordinate system of the current frame and/or the reference frame(s) may be scaled.
h. Alternatively, the geometry coordinates in the converted coordinate system of the current frame and/or the reference frame(s) may be scaled.
i. In one example, the converted coordinate system of the current frame and/or the reference frame(s) may be transformed.
j. Alternatively, the geometry coordinates in the converted coordinate system of the current frame and/or the reference frame(s) may be transformed.
   8) In one example, the attribute inter prediction may be performed after the geometry offset.
a. In one example, there may be offset to the geometry information of the reference frame and the current frame before the attribute inter prediction.
   i. In one example, the geometry offsets for the reference frame and the current frame may be the same.
      (1) In one example, the geometry offset for the reference frame and the current frame may be the minimum position of the geometry information of the two frames in one specific coordinate system.
      (2) In one example, the geometry offset for the reference frame and the current frame may be the minimum position of the geometry information of the multiple frames in one specific coordinate system.
         a. In one example, the multiple frames may be all decoded frames and the current frame.
         b. Alternatively, the multiple frames may be the previous N decoded frames and the current frame.
         c. Alternatively, the multiple frames may be all decoded frames after the last random access point frame, the last random access point frame and the current frame.
   ii. In one example, the geometry offsets for the reference frame and the current frame may different.
      (1) In one example, the geometry offset for one frame may be the minimum position of the geometry information of the frame in one specific coordinate system.
b. Alternatively, there may be no offset to the geometry information of the reference frame and the current frame before the attribute inter prediction.
   9) The frame distance may be in proportion to the distance of two frames in time stamp order.
a. In one example, the time stamp order may be the rendering order of frames.
b. In one example, the time stamp order may be the collection order of frames.
c. In one example, the frame distance between M-th frame and N-th frame may be in proportion to M−N or N−M or |M−N|.
d. In one example, the frame distance between one frame and itself may be 0.
e. In one example, the frame distance between the current frame and the reference frame may be derived at the encoder.
f. In one example, the frame distance between the current frame and the reference frame may be derived at the decoder.
g. Alternatively, the frame distance between the current frame and the reference frame may be signalled to the decoder.
i. In one example, the frame distance may be coded with fixed-length coding, unary coding, truncated unary coding, etc. al.
   ii. In one example, the frame distance may be coded in a predictive way.
h. A time stamp order indication may be signalled for a frame.
   10) The frame distance may be used in nearest neighbors search.
a. In one example, the geometric distance in nearest neighbors search may depend on the frame distance between the reference frame and the current frame.
b. In one example, the geometric distance of reference points in one reference frame with closer frame distance may be higher than that of one reference frame with farther frame distance.
   i. In one example, the geometric distance of reference points in one reference frame may be the sum of frame distance and the original geometric distance.
      11) The frame distance may be used in neighbor weights generation.
a. In one example, the generated neighbor weights may depend on the frame distance between the reference frame and the current frame.
b. In one example, the generated neighbor weights of reference points in one reference frame with a closer frame distance may be higher than that of one reference frame with a farther frame distance.
   i. In one example, the generated neighbor weights of reference points in one reference frame may be the sum of frame distance and the original generated neighbor weights.
      12) It is proposed to apply motion compensation to the reference frame before attribute inter prediction.
a. In one example, there may be motion estimation before the motion compensation process.
b. In one example, there may be motion compensation for the reference frame.
c. In one example, motion compensation may be applied to the reference frame before attribute inter prediction.
d. In one example, the reference frame with motion compensation may be used in the attribute inter prediction.
e. In one example, the reference frame without motion compensation may be used in the attribute inter prediction.
f. In one example, the indication to indicate whether motion compensation is applied may be signalled to the decoder.
   i. In one example, the indication may be coded with fixed-length coding, unary coding, truncated unary coding, etc. al.
   ii. In one example, the indication may be coded in a predictive way.
      13) It is proposed to use the compensated motion to decide whether the attribute inter prediction is applied.
a. In one example, the attribute inter prediction may be only applied to the reference frame with limited geometry move.
b. In one example, the geometry move may be indicated by the compensated motion.
c. In one example, the compensated motion may be composed of translation and rotation.
d. In one example, the translation may be recorded by the motion matrix/vector.
e. In one example, the rotation may be recorded by rotation matrix/vector.
f. In one example, the rotation may be recorded by Euler angle/quaternion/rotation angle.
g. In one example, the compensated motion may be rigid motion or non-rigid motion.
h. In one example, the compensated motion may be recorded by matrix.
i. In one example, the attribute inter prediction may be applied to the reference frame if the compensated motion is smaller than the compensated motion thresholds.
j. Alternatively, the attribute inter prediction may be applied to the reference frame if the translation is smaller than the translation thresholds.
k. Alternatively, the attribute inter prediction may be applied to the reference frame if the rotation is smaller than the rotation thresholds.
l. In one example, the thresholds may be pre-defined values.
m. Alternatively, the thresholds may be signalled to the decoder.
   i. In one example, the thresholds may be coded with fixed-length coding, unary coding, truncated unary coding, etc. al.
   ii. In one example, the thresholds may be coded in a predictive way.
      14) It is proposed to use the motion information to decide whether the attribute inter prediction is enabled to one frame.
a. In one example, the attribute inter prediction may be only applied to the reference frame with limited geometry move.
b. In one example, the geometry move may be indicated by the motion information.
   i. In one example, the motion information may be provided by the source.
   ii. Alternatively, the motion information may be generated by the motion estimation process.
   iii. Alternatively, the motion information may be indicated by the compensated motion.
c. In one example, the motion information may be composed of translation and rotation.
d. In one example, the translation may be recorded by the motion matrix/vector.
e. In one example, the rotation may be recorded by rotation matrix/vector.
f. In one example, the rotation may be recorded by Euler angle/quaternion/rotation angle.
g. In one example, the motion information may be rigid motion or non-rigid motion.
h. In one example, the motion information may be recorded by matrix.
i. In one example, the attribute inter prediction may be applied to the reference frame if the motion information is smaller than the motion information thresholds.
j. Alternatively, the attribute inter prediction may be applied to the reference frame if the translation is smaller than the translation thresholds.
k. Alternatively, the attribute inter prediction may be applied to the reference frame if the rotation is smaller than the rotation thresholds.
l. In one example, the thresholds may be pre-defined values.
m. Alternatively, the thresholds may be signalled to the decoder.
   i. In one example, the thresholds may be coded with fixed-length coding, unary coding, truncated unary coding, etc. al.
   ii. In one example, the thresholds may be coded in a predictive way.
      15) It is proposed to use the rate and/or distortion information to decide whether the attribute inter prediction is enabled to one frame.
a. In one example, the rate information may be the information to indicate the resource usage of the coding results.
   i. In one example, the rate information may be the size of the coding results.
   ii. Alternatively, the rate information may be the conversion of the size of the coding results.
   iii. Alternatively, the rate information may be the estimation of the size of the coding results.
b. In one example, the rate information may be estimated at the encoder.
   i. In one example, the rate information may be estimated by performing coding process and counting the rate results.
   ii. Alternatively, the rate information may be estimated by using rate estimation function, which provides an approximation of the coding process.
c. In one example, the distortion information may be the information to indicate the distortion between the original values and the reconstructed values.
   i. In one example, the distortion information may be the difference between the original values and the reconstructed values.
      (1) The difference may be represented by the error (such as mean square error, mean absolute error, root mean square error, sum of square errors, sum of absolute errors) between the original values and the reconstructed values.
   ii. Alternatively, the distortion information may be the conversion of the difference between the original values and the reconstructed values.
   iii. Alternatively, the distortion information may be the estimation of the difference between the original values and the reconstructed values.
d. In one example, the distortion information may be estimated at the encoder.
   i. In one example, the distortion information may be estimated by performing coding and reconstruction process and counting the distortion results.
   ii. Alternatively, the distortion information may be estimated by using distortion estimation function, which provides an approximation of the coding process.
e. In one example, the coding cost information may be derived based on the rate information and the distortion information at the encoder.
   i. In one example, the coding cost information may be the linear combination of the rate information and distortion information. Such as R+λ*D, wherein R is the rate information and D is the distortion information and λ is the linear parameter.
      (1) In one example, the linear parameter λ may be pre-defined.
      (2) Alternatively, the linear parameter λ may be derived based on the coding precision or the quantization precision.
f. In one example, the rate information may be used to decide whether the attribute inter prediction is enabled to one frame.
   i. In one example, only if the rate information of the attribute inter prediction is less than that of the attribute intra prediction, the attribute inter prediction is decided to be enabled.
g. In one example, the distortion information may be used to decide whether the attribute inter prediction is enabled to one frame.
   i. In one example, only if the distortion information of the attribute inter prediction is less than that of the attribute intra prediction, the attribute inter prediction is decided to be enabled.
h. In one example, the coding cost information may be used to decide whether the attribute inter prediction is enabled to one frame.
   i. In one example, only if the coding cost information of the attribute inter prediction is less than that of the attribute intra prediction, the attribute inter prediction is decided to be enabled.
i. In one example, after an encoder uses rate and/or distortion information to decide whether the attribute inter prediction is enabled to one frame, the decision may be signaled in the bitstream to inform the decoder.
j. In one example, the decoder may use the rate and/or distortion information to decide whether the attribute inter prediction is enabled to one frame.
   i. In one example, the decoder may use rate and/or distortion of previously decoded information to determine whether the attribute inter prediction is enabled to one frame/slice/block.
k. In the above description, frame may be replaced by slice/block or other process units.
   16) It is proposed to use the above information in combination to decide whether the attribute inter prediction is enabled to one frame.
a. The decision may be made at encoder or decoder.
   i. If the decision is made at decoder, decoder may use previously decoded information in a combination way to determine whether the attribute inter prediction is enabled to one frame/slice/block.
b. In one example, only if the geometry move is less than at least one threshold and the coding cost of the attribute inter prediction is less than that of the attribute intra prediction, the attribute inter prediction is decided to be enabled.
   i. In one example, the geometry move may be indicated by the compensated motion or the motion information.
   ii. In one example, the coding cost may be indicated by the rate information or the distortion information or the coding cost information.
c. In the above description, frame may be replaced by slice/block or other process units.
   17) It is proposed to signal whether the attribute inter prediction is applied to one reference frame.
a. In one example, there may be one indication to indicate whether the attribute inter prediction is applied to one reference frame.
b. In one example, the indication may be derived at the encoder.
c. In one example, the indication may be signalled to the decoder.
   i. In one example, the indication may be coded with fixed-length coding, unary coding, truncated unary coding, etc. al.
   ii. In one example, the indication may be coded in a predictive way.
      18) It is proposed to perform attribute compensation in attribute inter prediction.
a. In one example, the compensated attribute values may be derived based on the nearest neighbor search results and compensated parameters.
b. In one example, the compensated parameters may be fixed for the points in one point cloud cluster.
   i. In one example, the point cloud cluster may be consecutive M points.
c. In one example, the compensated parameters may be derived at the encoder.
d. In one example, the compensated parameters may be derived based on the attribute values of the inter nearest neighbors and the reconstructed values of the N previous coded points before the point cloud cluster.
e. Alternatively, the compensated parameters may be derived based on the prediction values and the reconstructed values of the N previous coded points before the point cloud cluster.
f. In one example, the compensated parameters may be derived at the decoder.
g. Alternatively, the compensated parameters may be signalled to the decoder.
   i. In one example, the compensated parameters may be coded with fixed-length coding, unary coding, truncated unary coding, etc. al.
   ii. In one example, the compensated parameters may be coded in a predictive way.
      19) Points in the different LODs of the reference frame may be searched in attribute inter prediction.
a. In one example, the points in the reference frame may be divided into one or multiple LODs.
b. In one example, the points in the current frame may be divided into one or multiple LODs.
c. In one example, there may be one LOD level referring the LOD for each point.
d. In one example, for current point, the points with the same LOD level in the reference frame may be searched to perform the nearest neighbor search.
e. In one example, for current point, the points with the lower LOD level in the reference frame may be searched to perform the nearest neighbor search.
f. In one example, for current point, the points with the higher LOD level in the reference frame may be searched to perform the nearest neighbor search.
g. In one example, for current point, the points in all LOD levels in the reference frame may be searched to perform the nearest neighbor search.
h. In one example, an indication to indicate whether the points in all LODs are searched may be signalled to the decoder.
   i. In one example, the indication may be coded with fixed-length coding, unary coding, truncated unary coding, etc. al.
   ii. In one example, the indication may be coded in a predictive way.
i. In one example, an indication to indicate whether only the points in the same LOD are searched may be signalled to the decoder.
   i. In one example, the indication may be conditionally signalled, e.g., according to whether the points in all LODs are searched.
   ii. In one example, the indication may be coded with fixed-length coding, unary coding, truncated unary coding, etc. al.
   iii. In one example, the indication may be coded in a predictive way.
      20) It is proposed to use multiple lists to store the search results in different frames and generate the predictor list by combining all lists.
a. In one example, there may be a first list (such as list1) to store the search results in the current frame.
b. In one example, there may be a second list (such as list2) to store the search results in each reference frame.
c. In one example, the nearest neighbor search in the current frame may only change the list1.
d. In one example, the nearest neighbor search in one reference frame may only change the corresponding list.
e. In one example, the information of the points in all lists may be used to generate the predictor list.
   21) The above mentioned ‘frame’ may be replaced by other processing unit, e.g., a sub-region within a frame.
   22) The above methods may be also applicable to other coding modules in G-PCC or other search methods in addition to the nearest neighbour search method.

### 6. Embodiments

1) This embodiment describes an example of how to use Manhattan distance to perform nearest neighbor search in attribute inter prediction. In this example, the search center in the reference frame is set to the point with the closest Morton code. The search range for the current frame and the reference frame are both set to 128.

For each frame, the reference frame is the previous one frame and the attribute inter prediction is performed at the encoder and the decoder.

Firstly, the points in the current frame and the reference frame are reordered. The Morton code of each point is calculated and the points in one frame are reordered based on the Morton code order.

Secondly, for each point in the current frame, 3 approximate nearest neighbors in the current frame and the reference frame are searched and stored in list1. There are 3 flags to indicate whether the nearest neighbor is from the current frame.
a. The search center for the current frame is the current point. The previous 128 points before the search center in Morton code order are traversed. At most 3 points with the closest Manhattan distance are selected from the traversed points. The position, flag and index of each point in list1 are recorded. The Manhattan distance d of two points (x₁, y₁, z₁) and (x₂, y₂, z₂) is computed as the following formula:

$$d = \vert {x}_{1} - {x}_{2} \vert + \vert {y}_{1} - {y}_{2} \vert + \vert {z}_{1} - {z}_{2} , \vert \qquad ( 6 - 1 )$$

b. The search center for the reference frame is the point with the closest Morton code to the current point in the reference frame. The previous 128 points before the search center in Morton code order, the following 128 points after the search center in Morton code order and the search center are traversed. If the Manhattan distance of the traversed point is closer than the point in list1, the list1 is updated by inserting the traversed points in list1 and removing the point with the highest Manhattan distance in list1. The position, flag and index of each point in list1 are recorded.

Thirdly, for each point in the current frame, the predictors are generated based on the information of the points in list1 and the predicted value is generated.
a. There is one weight value for each point in list1. The calculated distance for each point in list1 is calculated based on the Euclidean distance from the point to the current point. The calculated distance for point from the reference frame should be added 1. The weight value for each point in list1 is the reciprocal of the calculated distance. The Euclidean distance d of two points (x₁, y₁, z₁) and (x₂, y₂, z₂) is computed as the following formula:

$$d = \sqrt{{( {x}_{1} - {x}_{2} )}^{2} + {( {y}_{1} - {y}_{2} )}^{2} + {( {z}_{1} - {z}_{2} )}^{2}} , \qquad ( 6 - 2 )$$

b. The attribute for each point in list1 is obtained based on the index.
c. The variability of the attributes of the points in list1 is computed.
d. If the variability is less than a threshold, the weighted average value is used to predict the attribute of the current point.
e. Otherwise, the best predictor is selected by applying a RDO procedure. The candidate list of predictors includes the weighted average value and the attribute values of the points in list1. And the result of RDO process is signalled to the decoder. At the decoder, the predicted value will be generated based on the signalled RDO result.

Finally, for each point in the current frame, the residual between the attribute of the current frame and the predicted attribute value is coded and signalled to the decoder.

More details of the embodiments of the present disclosure will be described below which are related to inter prediction for point cloud attribute coding. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a slice, a block, or any other suitable processing unit.

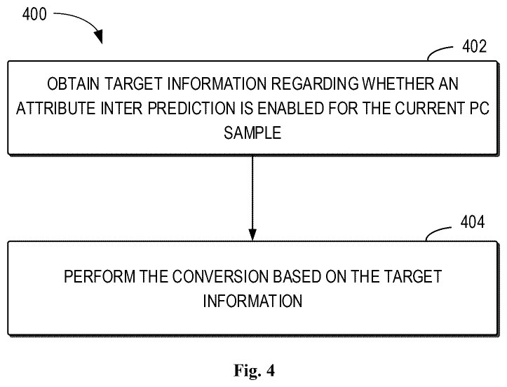

FIG. 4 illustrates a flowchart of a method 400 for point cloud coding in accordance with some embodiments of the present disclosure. The method 400 may be implemented during a conversion between a current PC sample of a point cloud sequence and a bitstream of the point cloud sequence. As shown in FIG. 4, the method 400 starts at 402, where target information regarding whether an attribute inter prediction is enabled for the current PC sample is obtained. The target information is determined based on rate information and/or distortion information associated with coding at least one target PC sample with the attribute inter prediction. The at least one target PC sample comprises the current PC sample and/or at least one PC sample of the point cloud sequence coded before the current PC sample.

In some embodiments, the target information may be determined at an encoder, and signaled in the bitstream. At a decoder, the target information may be obtained from the bitstream. By way of example rather than limitation, an indication indicating the target information may be comprised in the bitstream. The decoder may decode the indication from the bitstream, so as to obtain the target information. In some alternative embodiments, the decoder may determine the target information based on the rate information and/or distortion information.

At 404, the conversion is performed based on the target information. In some embodiments the conversion may include encoding the current PC sample into the bitstream. Alternatively or additionally, the conversion may include decoding the current PC sample from the bitstream.

In view of the above, information regarding whether an attribute inter prediction is enabled for the current PC sample is determined based on related rate information and/or distortion information. Compared with the conversion solution, the proposed method can advantageously reduce the coding bits while maintaining the coding quality. Thereby, the coding quality of point cloud coding can be improved.

In some embodiments, at 404, a second indication indicating whether an inter prediction is applied to the current PC sample may be obtained from the bitstream. Whether the attribute inter prediction is applied to the current PC sample may be determined based on the target information and the second indication. Moreover, the conversion may be performed based on the determination.

In some embodiments, the target information may be determined based on a geometry motion associated with the current PC sample and at least one of the rate information or the distortion information. By way of example rather than limitation, the geometry motion may comprise information used for performing a motion compensation on a reference PC sample for the current PC sample. Additionally or alternatively, the geometry motion may comprise motion information between the reference PC sample and the current PC sample.

In some embodiments, if the geometry motion is less than at least one threshold and a first coding cost is less than a second coding cost, the attribute inter prediction may be determined to be enabled for the current PC sample. The first coding cost may be associated with coding the at least one target PC sample with the attribute inter prediction, and the second coding cost may be associated with coding the at least one target PC sample with an attribute intra prediction. By way of example rather than limitation, the first coding cost may comprise the rate information, the distortion information, or cost information. The cost information may be determined based on the rate information and distortion information, which will be described in detail hereinafter.

In some embodiments, the rate information may indicate an amount of resource used for a coding result obtained by performing a coding process on the at least one target PC sample with the attribute inter prediction. In one example, the rate information may be a size of the coding result, such as the number of bits comprised in the coding result. In another example, the rate information may be a value determined based on the size. In a further example, the rate information may be an estimation of the size. It should be understood that the above examples are described merely for purpose of description. The scope of the present disclosure is not limited in this respect.

In some embodiments, the rate information may be determined at an encoder. In one example, the rate information may be determined based on the number of bits comprised in the coding result. By way of example, the bits in the coding result may be counted to obtain the number of bits. Alternatively, the rate information may be determined by using a rate estimation function. The rate estimation function provides an approximation of the coding process. By way of example rather than limitation, the rate estimation function may be based on information entropy.

In some embodiments, the distortion information may indicate a distortion between attribute values of points of the at least one target PC sample and reconstructed attribute values of the points. The reconstructed attribute values may be determined based on a coding result. The coding result may be obtained by performing a coding process on the at least one target PC sample with the attribute inter prediction. In one example, the distortion information may be a difference between the attribute values and the reconstructed attribute values. In another example, the distortion information may be a value determined based on the difference. In a further example, the distortion information may be an estimation of the difference. It should be understood that the above examples are described merely for purpose of description. The scope of the present disclosure is not limited in this respect.

In some embodiments, the difference may be determined to be an error metric between the attribute values and the reconstructed attribute values. By way of example rather than limitation, the error metric may comprise a mean square error, a mean absolute error, a root mean square error, a sum of square errors, a sum of absolute errors, and/or the like. It should be understood that the above examples are described merely for purpose of description. The scope of the present disclosure is not limited in this respect.

In some embodiments, the distortion information may be determined at an encoder. In one example, distortion results for respective points of the at least one target PC sample may be determined based on the coding result. A distortion result of a point may indicate a distortion between an attribute value of the point and a reconstructed attribute value of the point. The distortion information may be determined based on the distortion results. For example, the distortion information may be determined to be a sum of the distortion results or an average of the distortion results. In another example, the distortion information may be determined by using a distortion estimation function. The distortion estimation function may provide an approximation of the coding process. By way of example rather than limitation, the distortion estimation function may be based on information entropy.

In some embodiments, cost information may be determined based on the rate information and the distortion information. The target information may be determined based on the cost information. In one example, if a cost indicated by the cost information is less than a cost indicated by further cost information associated with coding the at least one target PC sample with an attribute intra prediction, the attribute inter prediction may be determined to be enabled for the current PC sample. In another example, if a cost indicated by the cost information is less than a pre-determined threshold, the attribute inter prediction may be determined to be enabled for the current PC sample. It should be understood that the above examples are described merely for purpose of description. The scope of the present disclosure is not limited in this respect.

In some embodiments, the cost information may be determined at an encoder. By way of example rather than limitation, a linear combination of the rate information and the distortion information may be determined as the cost information. For example, the linear combination may be determined by adding up the rate information and a product of a linear parameter and the distortion information. In one example, the linear parameter may be pre-defined. In another example, the linear parameter may be determined based on a coding precision for coding the current PC sample. In a further example, the linear parameter may be determined based on a quantization precision for coding the current PC sample. In aid of such a linear combination, rate-distortion optimization may be achieved and thus the coding quality may be improved. It should be understood that the cost information may also be determined by combining the rate information and the distortion information in any other suitable manner. The scope of the present disclosure is not limited in this respect.

In some embodiments, the target information may be determined based on the rate information. In one example, if an amount of resource indicated by the rate information is less than an amount of resource indicated by further rate information associated with coding the at least one target PC sample with an attribute intra prediction, the attribute inter prediction may be determined to be enabled for the current PC sample. Alternatively, if an amount of resource indicated by the rate information is less than a predetermined threshold, the attribute inter prediction may be determined to be enabled for the current PC sample. It should be understood that the above examples are described merely for purpose of description. The scope of the present disclosure is not limited in this respect.

In some alternative embodiments, the target information may be determined based on the distortion information. In one example, if a distortion indicated by the distortion information is less than a distortion indicated by further distortion information associated with coding the at least one target PC sample with an attribute intra prediction, the attribute inter prediction may be determined to be enabled for the current PC sample. Alternatively, if a distortion indicated by the distortion information is less than a predetermined threshold, the attribute inter prediction may be determined to be enabled for the current PC sample. It should be understood that the above examples are described merely for purpose of description. The scope of the present disclosure is not limited in this respect.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, target information regarding whether an attribute inter prediction is enabled for a current point cloud (PC) sample of the point cloud sequence is obtained. The target information is determined based on at least one of rate information or distortion information associated with coding at least one target PC sample with the attribute inter prediction. The at least one target PC sample comprises at least one of: the current PC sample, or at least one PC sample of the point cloud sequence coded before the current PC sample. Moreover, the bitstream is generated based on the target information.

According to still further embodiments of the present disclosure, a method for storing a bitstream of a point cloud sequence is provided. In the method, target information regarding whether an attribute inter prediction is enabled for a current point cloud (PC) sample of the point cloud sequence is obtained. The target information is determined based on at least one of rate information or distortion information associated with coding at least one target PC sample with the attribute inter prediction. The at least one target PC sample comprises at least one of: the current PC sample, or at least one PC sample of the point cloud sequence coded before the current PC sample. Moreover, the bitstream is generated based on the target information and the bitstream is stored in a non-transitory computer-readable recording medium.

Implementations of the present disclosure can be described in view of the following clauses, the features of which can be combined in any reasonable manner.

Clause 1. A method for point cloud coding, comprising: obtaining, for a conversion between a current point cloud (PC) sample of a point cloud sequence and a bitstream of the point cloud sequence, target information regarding whether an attribute inter prediction is enabled for the current PC sample, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and performing the conversion based on the target information.

Clause 2. The method of clause 1, wherein the target information is determined at an encoder and wherein obtaining the target information comprises: obtaining the target information from the bitstream.

Clause 3. The method of clause 1, wherein obtaining the target information comprises: determining the target information based on at least one of the rate information or the distortion information.

Clause 4. The method of any of clauses 1-3, wherein performing the conversion comprises: obtaining, from the bitstream, a second indication indicating whether an inter prediction is applied to the current PC sample; determining, based on the target information and the second indication, whether the attribute inter prediction is applied to the current PC sample; and performing the conversion based on the determination.

Clause 5. The method of any of clauses 1-4, wherein the target information is determined based on a geometry motion associated with the current PC sample and at least one of the rate information or the distortion information.

Clause 6. The method of clause 5, wherein the geometry motion comprises at least one of the following: information used for performing a motion compensation on a reference PC sample for the current PC sample, or motion information between the reference PC sample and the current PC sample.

Clause 7. The method of any of clauses 5-6, wherein if the geometry motion is less than at least one threshold and a first coding cost is less than a second coding cost, the attribute inter prediction is determined to be enabled for the current PC sample, wherein the first coding cost is associated with coding the at least one target PC sample with the attribute inter prediction, and the second coding cost is associated with coding the at least one target PC sample with an attribute intra prediction.

Clause 8. The method of clause 7, wherein the first coding cost comprises one of the following: the rate information, the distortion information, or cost information determined based on the rate information and distortion information.

Clause 9. The method of any of clauses 1-8, wherein the rate information indicates an amount of resource used for a coding result obtained by performing a coding process on the at least one target PC sample with the attribute inter prediction.

Clause 10. The method of clause 9, wherein the rate information comprises at least one of the following: a size of the coding result, a value determined based on the size, or an estimation of the size.

Clause 11. The method of any of clauses 1-10, wherein the rate information is determined at an encoder.

Clause 12. The method of any of clauses 9-11, further comprising: determining the rate information based on the number of bits comprised in the coding result.

Clause 13. The method of any of clauses 9-11, further comprising: determining the rate information by using a rate estimation function, the rate estimation function providing an approximation of the coding process.

Clause 14. The method of any of clauses 1-13, wherein the distortion information indicates a distortion between attribute values of points of the at least one target PC sample and reconstructed attribute values of the points, the reconstructed attribute values being determined based on a coding result, the coding result being obtained by performing a coding process on the at least one target PC sample with the attribute inter prediction.

Clause 15. The method of clause 14, wherein the distortion information comprises at least one of the following: a difference between the attribute values and the reconstructed attribute values, a value determined based on the difference, or an estimation of the difference.

Clause 16. The method of clause 15, wherein the difference is determined to be an error metric between the attribute values and the reconstructed attribute values.

Clause 17. The method of clause 16, wherein the error metric comprises at least one of the following: a mean square error, a mean absolute error, a root mean square error, a sum of square errors, or a sum of absolute errors.

Clause 18. The method of any of clauses 1-17, wherein the distortion information is determined at an encoder.

Clause 19. The method of any of clauses 14-18, further comprising: determining distortion results for respective points of the at least one target PC sample based on the coding result, a distortion result of a point indicating a distortion between an attribute value of the point and a reconstructed attribute value of the point; and determining the distortion information based on the distortion results.

Clause 20. The method of any of clauses 14-18, further comprising: determining the distortion information by using a distortion estimation function, the distortion estimation function providing an approximation of the coding process.

Clause 21. The method of any of clauses 1-20, wherein the target information is determined by: determining cost information based on the rate information and the distortion information; and determining the target information based on the cost information.

Clause 22. The method of clause 21, wherein the cost information is determined at an encoder.

Clause 23. The method of any of clauses 21-22, wherein determining the cost information comprises: determining a linear combination of the rate information and the distortion information as the cost information.

Clause 24. The method of clause 23, wherein the linear combination is determined by adding up the rate information and a product of a linear parameter and the distortion information.

Clause 25. The method of clause 24, wherein the linear parameter is pre-defined.

Clause 26. The method of clause 24, wherein the linear parameter is determined based on a coding precision or a quantization precision for coding the current PC sample.

Clause 27. The method of any of clauses 15-20, wherein if a cost indicated by the cost information is less than a cost indicated by further cost information associated with coding the at least one target PC sample with an attribute intra prediction, the attribute inter prediction is determined to be enabled for the current PC sample.

Clause 28. The method of any of clauses 1-20, wherein the target information is determined based on the rate information.

Clause 29. The method of clause 28, wherein if an amount of resource indicated by the rate information is less than an amount of resource indicated by further rate information associated with coding the at least one target PC sample with an attribute intra prediction, the attribute inter prediction is determined to be enabled for the current PC sample.

Clause 30. The method of any of clauses 1-20, wherein the target information is determined based on the distortion information.

Clause 31. The method of clause 30, wherein if a distortion indicated by the distortion information is less than a distortion indicated by further distortion information associated with coding the at least one target PC sample with an attribute intra prediction, the attribute inter prediction is determined to be enabled for the current PC sample.

Clause 32. The method of any of clauses 1-31, wherein a PC sample is one of the following: a frame, a slice, or a block.

Clause 33. The method of any of clauses 1-32, wherein the conversion includes encoding the current PC sample into the bitstream.

Clause 34. The method of any of clauses 1-32, wherein the conversion includes decoding the current PC sample from the bitstream.

Clause 35. An apparatus for point cloud coding comprising a processor and a non-transitory memory with instructions thereon, wherein the instructions upon execution by the processor, cause the processor to perform a method in accordance with any of clauses 1-34.

Clause 36. A non-transitory computer-readable storage medium storing instructions that cause a processor to perform a method in accordance with any of clauses 1-34.

Clause 37. A non-transitory computer-readable recording medium storing a bitstream of a point cloud sequence which is generated by a method performed by an apparatus for point cloud coding, wherein the method comprises: obtaining target information regarding whether an attribute inter prediction is enabled for a current point cloud (PC) sample of the point cloud sequence, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and generating the bitstream based on the target information.

Clause 38. A method for storing a bitstream of a point cloud sequence, comprising: obtaining target information regarding whether an attribute inter prediction is enabled for a current point cloud (PC) sample of the point cloud sequence, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; generating the bitstream based on the target information; and storing the bitstream in a non-transitory computer-readable recording medium.

### Example Device

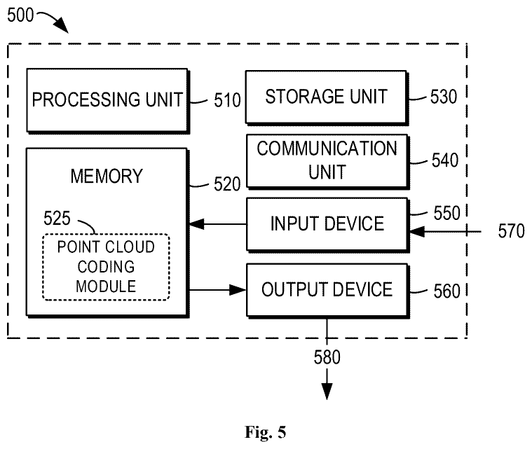

FIG. 5 illustrates a block diagram of a computing device 500 in which various embodiments of the present disclosure can be implemented. The computing device 500 may be implemented as or included in the source device 110 (or the GPCC encoder 116 or 200) or the destination device 120 (or the GPCC decoder 126 or 300).

It would be appreciated that the computing device 500 shown in FIG. 5 is merely for purpose of illustration, without suggesting any limitation to the functions and scopes of the embodiments of the present disclosure in any manner.

As shown in FIG. 5, the computing device 500 includes a general-purpose computing device 500. The computing device 500 may at least comprise one or more processors or processing units 510, a memory 520, a storage unit 530, one or more communication units 540, one or more input devices 550, and one or more output devices 560.

In some embodiments, the computing device 500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 500 can support any type of interface to a user (such as “wearable” circuitry and the like).

The processing unit 510 may be a physical or virtual processor and can implement various processes based on programs stored in the memory 520. In a multi-processor system, multiple processing units execute computer executable instructions in parallel so as to improve the parallel processing capability of the computing device 500. The processing unit 510 may also be referred to as a central processing unit (CPU), a microprocessor, a controller or a microcontroller.

The computing device 500 typically includes various computer storage medium. Such medium can be any medium accessible by the computing device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk or another other media, which can be used for storing information and/or data and can be accessed in the computing device 500.

The computing device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further computing device via the communication medium. In addition, the functions of the components in the computing device 500 can be implemented by a single computing cluster or multiple computing machines that can communicate via communication connections. Therefore, the computing device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the computing device 500 can further communicate with one or more external devices (not shown) such as the storage devices and display device, with one or more devices enabling the user to interact with the computing device 500, or any devices (such as a network card, a modem and the like) enabling the computing device 500 to communicate with one or more other computing devices, if required. Such communication can be performed via input/output (I/O) interfaces (not shown).

In some embodiments, instead of being integrated in a single device, some or all components of the computing device 500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 500 may be used to implement point cloud encoding/decoding in embodiments of the present disclosure. The memory 520 may include one or more point cloud coding modules 525 having one or more program instructions. These modules are accessible and executable by the processing unit 510 to perform the functionalities of the various embodiments described herein.

In the example embodiments of performing point cloud encoding, the input device 550 may receive point cloud data as an input 570 to be encoded. The point cloud data may be processed, for example, by the point cloud coding module 525, to generate an encoded bitstream. The encoded bitstream may be provided via the output device 560 as an output 580.

In the example embodiments of performing point cloud decoding, the input device 550 may receive an encoded bitstream as the input 570. The encoded bitstream may be processed, for example, by the point cloud coding module 525, to generate decoded point cloud data. The decoded point cloud data may be provided via the output device 560 as the output 580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for point cloud coding, comprising:
obtaining, for a conversion between a current point cloud (PC) sample of a point cloud sequence and a bitstream of the point cloud sequence, target information regarding whether an attribute inter prediction is enabled for the current PC sample, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and
performing the conversion based on the target information.

2. The method of claim 1, wherein the target information is determined at an encoder and wherein obtaining the target information comprises: obtaining the target information from the bitstream, or
wherein obtaining the target information comprises: determining the target information based on at least one of the rate information or the distortion information, or
wherein performing the conversion comprises:
obtaining, from the bitstream, a second indication indicating whether an inter prediction is applied to the current PC sample;
determining, based on the target information and the second indication, whether the attribute inter prediction is applied to the current PC sample; and
performing the conversion based on the determination.

3. The method of claim 1, wherein the target information is determined based on a geometry motion associated with the current PC sample and at least one of the rate information or the distortion information.

4. The method of claim 3, wherein the geometry motion comprises at least one of the following: information used for performing a motion compensation on a reference PC sample for the current PC sample, or motion information between the reference PC sample and the current PC sample, or
wherein if the geometry motion is less than at least one threshold and a first coding cost is less than a second coding cost, the attribute inter prediction is determined to be enabled for the current PC sample, wherein the first coding cost is associated with coding the at least one target PC sample with the attribute inter prediction, and the second coding cost is associated with coding the at least one target PC sample with an attribute intra prediction.

5. The method of claim 4, wherein the first coding cost comprises one of the following:
the rate information,
the distortion information, or
cost information determined based on the rate information and distortion information.

6. The method of claim 1, wherein the rate information indicates an amount of resource used for a coding result obtained by performing a coding process on the at least one target PC sample with the attribute inter prediction.

7. The method of claim 6, wherein the rate information comprises at least one of the following:
a size of the coding result,
a value determined based on the size, or
an estimation of the size.

8. The method of claim 6, further comprising:
determining the rate information based on a number of bits comprised in the coding result, or
determining the rate information by using a rate estimation function, the rate estimation function providing an approximation of the coding process.

9. The method of claim 1, wherein the distortion information indicates a distortion between attribute values of points of the at least one target PC sample and reconstructed attribute values of the points, the reconstructed attribute values being determined based on a coding result, the coding result being obtained by performing a coding process on the at least one target PC sample with the attribute inter prediction.

10. The method of claim 9, wherein the distortion information comprises at least one of the following: a difference between the attribute values and the reconstructed attribute values, a value determined based on the difference, or an estimation of the difference, or
wherein the method further comprises: determining distortion results for respective points of the at least one target PC sample based on the coding result, a distortion result of a point indicating a distortion between an attribute value of the point and a reconstructed attribute value of the point; and determining the distortion information based on the distortion results, or
wherein the method further comprises: determining the distortion information by using a distortion estimation function, the distortion estimation function providing an approximation of the coding process.

11. The method of claim 1, wherein the target information is determined by:
determining cost information based on the rate information and the distortion information; and
determining the target information based on the cost information.

12. The method of claim 11, wherein the cost information is determined at an encoder, or
wherein determining the cost information comprises: determining a linear combination of the rate information and the distortion information as the cost information.

13. The method of claim 11, wherein if a cost indicated by the cost information is less than a cost indicated by further cost information associated with coding the at least one target PC sample with an attribute intra prediction, the attribute inter prediction is determined to be enabled for the current PC sample.

14. The method of claim 1, wherein the target information is determined based on the rate information, or
wherein the target information is determined based on the distortion information.

15. The method of claim 14, wherein if an amount of resource indicated by the rate information is less than an amount of resource indicated by further rate information associated with coding the at least one target PC sample with an attribute intra prediction, the attribute inter prediction is determined to be enabled for the current PC sample, or
wherein if a distortion indicated by the distortion information is less than a distortion indicated by further distortion information associated with coding the at least one target PC sample with an attribute intra prediction, the attribute inter prediction is determined to be enabled for the current PC sample.

16. The method of claim 1, wherein a PC sample is one of the following:
a frame,
a slice, or
a block.

17. The method of claim 1, wherein the conversion includes encoding the current PC sample into the bitstream, or
wherein the conversion includes decoding the current PC sample from the bitstream.

18. An apparatus for point cloud coding comprising a processor and a non-transitory memory with instructions thereon, wherein the instructions upon execution by the processor, cause the processor to perform acts comprising:
obtaining, for a conversion between a current point cloud (PC) sample of a point cloud sequence and a bitstream of the point cloud sequence, target information regarding whether an attribute inter prediction is enabled for the current PC sample, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and
performing the conversion based on the target information.

19. A non-transitory computer-readable storage medium storing instructions that cause a processor to perform acts comprising:
obtaining, for a conversion between a current point cloud (PC) sample of a point cloud sequence and a bitstream of the point cloud sequence, target information regarding whether an attribute inter prediction is enabled for the current PC sample, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and
performing the conversion based on the target information.

20. A non-transitory computer-readable recording medium storing a bitstream of a point cloud sequence which is generated by a method performed by an apparatus for point cloud coding, wherein the method comprises:
obtaining target information regarding whether an attribute inter prediction is enabled for a current point cloud (PC) sample of the point cloud sequence, the target information being determined based on at least one of rate information or distortion information associated with coding at least one target PC sample with the attribute inter prediction, wherein the at least one target PC sample comprises at least one of: the current PC sample, or at least one PC sample of the point cloud sequence coded before the current PC sample; and
generating the bitstream based on the target information.
